(19) United States
(12) Patent Application Publication
(10) Pub. No.: US 2021/0031473 A1
(43) Pub. Date: Feb. 4, 2021

(54) ARTICLE COMPRISING A FABRIC LAYER TREATED WITH PARTLY OXIDIZED POLYETHYLENE

(71) Applicant: ContiTech Antriebssysteme GmbH, Hannover (DE)

(72) Inventors: Henning Kanzow, Wedemark (DE); Stephanie Kautz, Hannover (DE); Christian Greiner, Hannover (DE); Reinhard Teves, Seelze (DE)

(73) Assignee: ContiTech Antriebssysteme GmbH, Hannover (DE)

(21) Appl. No.: 17/046,117

(22) PCT Filed: Mar. 26, 2019
(86) PCT No.: PCT/EP2019/057506

§ 371 Date: Oct. 8, 2020

(30) Foreign Application Priority Data
Apr. 26, 2018 (DE) 10 2018 206 484.9

(51) Int. Cl. B29D 29/08; F16G 1/10; F16G 5/08; C08L 23/16

(52) U.S. Cl. CPC B29D 29/08; F16G 1/10; B29L 2031/7094; C08L 23/16; F16G 5/08

(57) ABSTRACT

The present invention relates to an article having an elastic main body based on at least one thermoplastic elastomer or based on a vulcanizate having an article surface provided with a textile cover ply, characterized in that the textile cover ply is treated with partially oxidized polyethylene, and to processes for producing such an article.

The present invention relates to an article having an elastic main body based on at least one thermoplastic elastomer or based on a vulcanizate having an article surface provided with a textile cover ply, characterized in that the textile cover ply is treated with partially oxidized polyethylene, and to processes for producing such an article.

An article exposed to dynamic stresses and thus also to wear as well as noise development is for example a band, strap, belt, hose, air spring bellows, expansion joint or a multilayered fabric web, wherein the belt in the form of a drive belt, and here especially the V-ribbed belt, is of particular importance. The main body of the drive belt comprises a top ply as the belt backing and a substructure with a force transmission zone. In this regard, reference is made in particular to the patent applications DE 38 23 157 A1, DE 10 2006 007 509 A1, WO 2005/080821 A1, WO 2006/066669 A1 and also to the U.S. Pat. Nos. 3,981,206 and 5,417,618. A drive belt has elasticity because the main body and thus the top ply and the substructure consist of a polymeric material having elastic properties, for which in particular the two groups of materials known as elastomers and thermoplastic elastomers (TPEs) are suitable. The elastic main body further usually incorporates an embedded strength member or tensile member, which may have one or more plies.

Drive belts have a coating in particular in the region of the force transmission zone in particular for noise reduction as well as enhanced abrasion resistance.

Various coating types are already known for drive belts. European patent application EP 1 431 358 A1 discloses for example a lacquer coating based on acrylate and polyurethane. This coating is not permanent on some engines, which is associated with a loss of function due to wear. In addition, the drying time for the lacquer also hinders an efficient manufacturing process.

The international patent application WO 02/084144 A1 describes a toothed belt with a thermoplastic surface layer made of polyethylene (UHMWPE) to obtain improved abrasion resistance. However, such a coating is very brittle at low temperatures and is therefore unsuitable for V-ribbed belts in particular. European patent application EP 2 664 645 A1 discloses drive belts, in particular V-ribbed belts, having a coating in the form of a film of polyethylene (LDPE, HDPE and LLDPE), which are characterized by good abrasion behavior and, in some cases, good noise characteristics. However, in V-ribbed belts, these coatings result in usually undesired, very high coefficients of friction (CoF values). In addition, bending flexibility is usually insufficient at low temperatures in the case of HDPE.

Textile cover plies are still used for coating. In particular textile cover plies in the form of a nonwoven, in the form of a woven or in the form of knits (i.e. in the form of a drawn-loop knit or formed-loop knit) are known in the prior art (cf. for example WO 2011/110372 A1, DE 10 2007 062 285 A1, DE 10 2006 007 509 A1 and U.S. Pat. No. 4,027,545).

Nonwoven coatings which in some cases additionally comprise embedded lubricants are known inter alia from U.S. Pat. No. 6,793,599 B2, U.S. Pat. No. 6,824,485 B2, U.S. Pat. No. 6,609,990 B2 and U.S. Pat. No. 4,892,510 B1. Classical nonwovens made of materials which do not melt under vulcanization conditions show a poor abrasion resistance which is insufficient for use in frictionally engaged drive belts, for example in V-ribbed belts for passenger car applications. Classical nonwovens are moreover not sufficiently elastic to allow in particular the molding of V-ribbed belts in the shaping process. The vulcanizate penetration caused thereby may impair the noise characteristics.

EP 2 166 251 A1, DE 10 2006 007 509 A1, U.S. Pat. No. 6,443,866 B1 or DE 10 2008 055 497 A1 describe textile cover plies which are in part coated with plastic, inter alia with polyethylene layers, as an adhesive layer/adhesion promoter between the elastic main body and the textile coating. However, these adhesion layers show no effect in terms of the bending fatigue life of the belts,

V-ribbed belts whose textile coating contains cellulose fibers such as cotton (cf. for example DE 10 2007 042 917.9) exhibit particularly advantageous noise characteristics under both dry and wet conditions. However, such belts too sometimes have insufficient bending fatigue life and wear resistance.

The present invention accordingly has for its object to provide an article having a coating which features improved bending fatigue life together with reduced heat aging and improved abrasion resistance coupled with advantageous coefficients of friction and noise characteristics under both wet and dry conditions.

This object is achieved by means of the embodiments characterized in the claims.

The invention especially provides an article having an elastic main body based on at least one thermoplastic elastomer or based on a vulcanizate having an article surface provided with a textile cover ply, characterized in that the textile cover ply is treated with partially oxidized polyethylene.

The article according to the invention may be any suitable article. The article according to the invention is preferably in the form of a band (for example a conveyor), strap, belt, hose, air spring bellows (in particular axial bellows or cross-ply bellows), expansion joint or a multilayered fabric web. The article is particularly preferably in the form of a drive belt. The elastic main body comprises a top ply as the belt backing and a substructure having a force transmission zone, wherein the top ply and/or the force transmission zone are provided with the textile cover ply. The drive belt is particularly preferably in the form of a flat belt, V-belt (for example in the form of a raw-edge or wrapped V-belt), V-ribbed belt, toothed belt, clutch belt or elevator belt.

The article according to the invention comprises an elastic main body based on at least one thermoplastic elastomer or based on a vulcanizate. The term elastomer is to be understood as meaning dimensionally stable yet elastically deformable plastics having a glass transition point below room/operating temperature. The vulcanizate is preferably in the form of a vulcanized rubber mixture containing at least one rubber component and mixture ingredients. Employed rubber components especially include an ethylene-propylene copolymer (EPM), an ethylene-propylene-diene copolymer (EPDM), (partially) hydrogenated nitrile rubber (HNBR), chloroprene rubber (CR), fluororubber (FKM), natural rubber (NR), styrene-butadiene rubber (SBR) or butadiene rubber (BR) which are unblended or blended with at least one further rubber component, in particular with one of the abovementioned rubber types, for example in the form of an EPM/EPDM or SBR/BR blend.

In a particularly preferred embodiment, the rubber component comprises ethylene-propylene copolymer (EPM), ethylene-propylene-diene copolymer (EPDM) or a blend of ethylene-propylene copolymer (EPM) and ethylene-propylene-diene copolymer (EPDM) (also known as EPM/EPDM blend). In addition to the other advantageous properties, the use of these materials achieves enhanced adhesion between the elastic main body and the textile cover ply.

The mixture ingredients preferably comprise at least one crosslinker or crosslinker system (crosslinking agent and accelerator). It is preferable to employ peroxides as crosslinkers due to their better heat aging resistance. Further mixture ingredients are usually a filler and/or a processing auxiliary and/or a plasticizer and/or an aging stabilizer and optionally further additives, for example fibers and color pigments. Reference is made in this connection to the general prior art in rubber mixing technology.

The inventive article further comprises at least one article surface provided with a textile cover ply. In one embodiment, only one article surface is provided with a textile cover ply. In another embodiment, a plurality of article surfaces (especially two article surfaces) are provided with a textile cover ply, wherein the textile cover plies may be identical or different.

The textile cover ply may be any desired suitable textile cover ply. In a preferred embodiment of the present invention, the textile cover ply is selected from the group consisting of wovens, formed-loop knits, drawn-loop knits, nonwovens and combinations thereof. The textile cover ply preferably comprises a material selected from the group consisting of cellulose (in particular cotton (CO), viscose (CV), sisal, hemp or linen), silk, cashmere, horsehair, aramid (AR), polyurethane (PU), polybenzimidazole (PBI), melamine (MEL), polybenzoxazole (PBO), carbon, polyamide (PA) (especially PA6.6, PA12, PA6), polycarbonate (PC), polyethylene (PE) (especially UHMWPE), polypropylene (PP), polystyrene (PS), polyacrylic (PAN), acetate (CA), triacetate (CTA), polyvinyl alcohol (PVA), polyamideimide (PAI), polytrimethylene terephthalate (PTT), polyimide (PI), polybutylene terephthalate (PBT), polytetrafluoroethylene (PTFE), polyphenylene sulfide (PPS), polyetheretherketone (PEEK), polyester (PES) (especially polyethylene terephthalate (PET)) and combinations thereof. The textile cover ply particularly preferably comprises a material selected from cotton (CO), viscose (CV), PA6.6, PA6, PET, polyurethane or combinations thereof.

If the textile cover ply is a woven, formed-loop knit or drawn-loop knit, this is preferably produced from one or more yarns of the abovementioned materials. However, it is also possible to use mixed fiber yarns (for example consisting of cotton fibers and polyester fibers). If the textile cover ply is a nonwoven, this may consist of fibers of one or more of the abovementioned materials.

If the textile cover ply is a formed-loop knit or drawn-loop knit, it is preferable when at least one further additional thread for stabilizing the formed-loop knit or drawn-loop knit in the manufacturing process is present. Employable additional threads are for example polyurethane threads (for example an elastane yarn). The advantage of using an additional polyurethane thread is that this makes it possible to achieve a high stretchability in the transverse direction as is required when using the textile on the ribbed side of V-ribbed belts since it would not otherwise be possible to mold the ribs. Such an arrangement also achieves a certain longitudinal stretching since the textile is stretched over reverse-side rollers as the belt rotates. If the article is a V-ribbed belt, it is preferable to use a textile cover ply which is elastic both in the longitudinal direction and in the transverse direction, for example a drawn-loop knit or formed-loop knit comprising elastane. In the case of toothed belts, by contrast, a high stretchability of the textile is required especially in the longitudinal direction (direction of rotation) in order to allow the teeth to be molded.

The present invention is especially characterized in that the textile cover ply is treated with partially oxidized polyethylene.

According to the invention, the term partially oxidized polyethylene is to be understood as meaning predominantly linear polyethylene waxes which are products having relatively low (weight-average) molecular weights in the range from 500 to 50 000 g/mol. Production of the polyethylene waxes is generally carried out by direct low-pressure polymerization or, preferably, high-pressure polymerization of the monomers or by targeted depolymerization of products of higher molar masses. The modified polyethylene waxes employed according to the invention may be produced by polymerization of ethylene, preferably in the absence of a catalyst, with premature polymerization termination and subsequent oxidation, for example by introduction of air, or by copolymerization of ethylene with suitable other monomers such as for example acrylic acid, wherein the proportion of acrylic acid units preferably does not exceed 20%, in particular 10%. It is finally also possible to improve the dispersibility of polyolefins by oxidative surface treatment. Overviews of this topic may be found for example in Ullmanns Enzyklopadie der technischen Chemie [Ullmann's Encyclopedia of Industrial Chemistry], 4th Ed., 24, 36 and in Encycl. Polym. Sci. Eng. 17, 792f. Such polyethylene waxes are commercially available as aqueous dispersions and typically have a solids content of up to 45% by weight, preferably up to 25% by weight.

In the context of the present invention, the textile cover ply is preferably treated with an oxidized HDPE wax having an average (weight-average) molecular weight in the range from 500 to 50 000 g/mol and especially 2000 to 10 000 g/mol. It is particularly preferable when the HDPE wax has an average molecular weight in the range from 5000 to 8000 g/mol.

The textile cover ply may be treated with the partially oxidized polyethylene in any suitable manner. For example, the textile cover ply as a whole may be treated with the partially oxidized polyethylene, either before or after the textile cover ply has been applied to the surface of the elastic main body of the article according to the invention. However, it is also possible for the fibers or yarns from which the textile cover ply is subsequently produced to be treated with the partially oxidized polyethylene.

Providing the textile cover ply with partially oxidized polyethylene surprisingly results in an article having improved bending fatigue life and wear resistance. Equally good friction properties and equally good noise characteristics under wet and dry conditions as for articles with untreated textile cover plies are also achieved.

In a particularly preferred embodiment of the present invention, the article according to the invention is in the form of a V-ribbed belt, wherein the elastic main body is a vulcanizate based on ethylene-propylene copolymer (EPM), ethylene-propylene-diene copolymer (EPDM) or a blend of ethylene-propylene copolymer (EPM) and ethylene-propylene-diene copolymer (EPDM) and wherein the textile cover ply comprises a drawn-loop knit or formed-loop knit made of cotton. It is especially preferable for the textile cover ply to further comprise an elastane yarn.

The textile cover ply may additionally be provided with an adhesive on the side facing the article side. It may also be impregnated with a polymer solution, especially with a view to altering the CoF value. The use of a polymer layer, in particular a polymer film, wherein said film is preferably based on polyethylene (for example LDPE), is also advantageous.

The adhesive and/or the polymer solution may additionally further contain a dry lubricant, in the case of the polymer solution especially to reduce the coefficient of friction. The dry lubricant is preferably a fluoroplastic, for example polytetrafluoroethylene (PTFE) and/or polyvinyl fluoride (PVF) and/or polyvinylidene fluoride (PVDF), in particular polytetrafluoroethylene (PTFE).

The adhesive and/or the polymer solution may further have been made electrically conductive, especially on the basis of carbon black and/or graphite and/or a metal additive. The use of an electrically conductive carbon black is of particular importance.

As previously explained hereinabove, the article according to the invention is preferably in the form of a band (for example a conveyor), strap, belt, hose, air spring bellows (in particular axial bellows or cross-ply bellows), expansion joint or a multilayered fabric web. The article is particularly preferably in the form of a drive belt. The elastic main body comprises a top ply as the belt backing and a substructure having a force transmission zone, wherein the top ply and/or the force transmission zone are provided with the textile cover ply. The drive belt is particularly preferably in the form of a flat belt, V-belt (for example in the form of a raw-edge or wrapped V-belt), V-ribbed belt, toothed belt, clutch belt or elevator belt.

The textile cover ply may also be applied as a tooth coating in a toothed belt, wherein said belt is preferably elastic at least in the circumferential direction of the belt. This is done by using the web material to produce a hose which is drawn over the toothed belt mold. The cords are then wound on before a mixture sheet is attached to the cord ply. The backing fabric of toothed belts or a hose having an inner formed-loop knit may also be provided with the textile cover ply according to the invention.

The present invention further relates to various processes for producing the article according to the invention.

In a first embodiment, the present invention relates to a process for producing the article according to the invention, comprising the steps of (a) treating a sheetlike textile with partially oxidized polyethylene and (b) applying the sheetlike textile treated with partially oxidized polyethylene to the surface of an elastic main body based on at least one thermoplastic elastomer or based on a vulcanizate.

This process accordingly comprises initially treating a sheetlike textile with the partially oxidized polyethylene and applying the thus-treated sheetlike textile to the elastic main body to form the inventive article having a textile cover ply. This treatment may be carried out in any suitable manner. In a preferred embodiment, the treating of the sheetlike textile with partially oxidized polyethylene is carried out by immersing the sheetlike textile in a suspension or emulsion containing partially oxidized polyethylene. To this end, the suspension or emulsion contains partially oxidized polyethylene preferably in a concentration of 10 to 200 g/l, preferably in the range from 20 to 60 g/l. In an alternative embodiment, the treating of the sheetlike textile with partially oxidized polyethylene is carried out by spraying the sheetlike textile with a suspension or emulsion containing partially oxidized polyethylene.

After the immersing or spraying, the treated sheetlike textile is dried and then used for constructing the article according to the customary procedure known to those skilled in the art. In the case of a V-ribbed belt, the sheetlike textile provided with oxidized polyethylene (optionally before vulcanization in a ribbed hollow mold) is placed on the blank belt sleeve on the substructure mixture sheet.

In a further embodiment, the present invention relates to a process for producing the article according to the invention, comprising the steps of (a) treating fibers or yarns with partially oxidized polyethylene, (b) producing a sheetlike textile from the fibers or yarns treated with partially oxidized polyethylene and (c) applying the sheetlike textile to the surface of an elastic main body based on at least one thermoplastic elastomer or based on a vulcanizate.

This process thus does not comprise treating the finished sheetlike textile but rather the fibers or yarns from which the sheetlike textile is subsequently produced. The yarns are thus treated prior to the weaving or knitting process for example. Preferably also carried out beforehand is a thermal treatment of the fibers or yarns such that the oxidized polyethylene melts and thus better adheres to the fibers or yarns. Here too, the treatment of the fibers or yarns with the oxidized polyethylene may be carried out by immersing the fibers or yarns in a suspension or emulsion containing partially oxidized polyethylene or by spraying them with such a suspension or emulsion.

In a further embodiment, the present invention relates to a process for producing the article according to the invention, comprising the steps of (a) providing an article with an elastic main body based on at least one thermoplastic elastomer or based on a vulcanizate having an article surface provided with an (untreated) textile cover ply and (b) treating the textile cover ply with partially oxidized polyethylene by immersing the article in a suspension or emulsion containing partially oxidized polyethylene or by spraying the article with a suspension or emulsion containing partially oxidized polyethylene.

This process comprises initially producing an article consisting of an elastic main body and an untreated textile cover ply and subsequently treating said article with partially oxidized polyethylene.

The invention will now be explained in more detail on the basis of examples.

### EXAMPLES

Four different V-ribbed belt types were produced by the molding process, wherein in each case the articles of examples A and B and examples C and D have the same cover plies, substructure mixtures, polyester cords and adhesive layers for the textile coating. The articles of examples A and B utilized the same cotton-elastane knit, but in example B the textile cover ply was provided with 6.5 g/m² of oxidized HDPE before being applied to the blank sleeve. Analogously, the articles of examples C and D utilized the same slightly heavier cotton-elastane knit, but for example D the textile cover ply was provided with 8 g/m² of oxidized HDPE before being applied to the blank sleeve. The coils were heated in hollow V-ribbed belt molds and parted off as 6PK1378 belts (see ISO 9982). The belts of types A and B differed from types C and D not only in the textile coatings but also in the rubber mixtures (vulcanizates) and in the profile depths, which in turn was apparent from the belt heights. The employed rubber mixtures (referred to in the table below as EPDM1 and EPDM2) were peroxidically crosslinked EPDM mixtures having different formulations, i.e. different filler contents and degrees of crosslinking.

Belt types A, B, C, D were then tested for durability and heat aging on a hot bending fatigue life test rig, a visual inspection of the belt being carried out daily. In this test, V-ribbed belts normally exhibit first cracks and then chunk outs after a certain running time. The test was in each case terminated when three or more cracks or one or more chunk outs were observed in the substructure. The test was a five-pulley test (drive pulley diameter=60 mm, additional pulleys=50 mm) based on the VDA hot bending fatigue life test (as at 09.27.2005), which in turn uses nine pulleys. In a further departure from the VDA test, the test was carried out at a constant ambient temperature of 130° C.

Furthermore, the coefficient of friction (CoF) according to SAE J2432, 2015 edition, was determined under wet and dry conditions.

Finally, wear tests were carried out on a diesel engine (running time 72 hours). This comprised measuring the mass loss of the belts using a balance.

The oxidized polyethylene employed was the commercially available product “POLYAVIN COP” from Bezema and an aqueous suspension comprising 40 g/l of this product was formulated. The active substance in “POLYAVIN COP” is oxidized HDPE having a (weight-average) molecular weight of 5000 to 8000.

The following table summarizes the results obtained for examples A to D:

| Example | A (Comparative) | | B | | C (Comparative) | | D | |
|---|---|---|---|---|---|---|---|---|
| Belt height | 4.1 | mm | 4.1 | mm | 4.7 | mm | 4.7 | mm |
| Belt length | 6PK1378 | | 6PK1378 | | 6PK1329 | | 6PK1329 | |
| Substructure | EPDM 1 | | EPDM 1 | | EPDM 2 | | EPDM 2 | |
| Basis weight of pure textile | 180 | g/m² | 180 | g/m² | 225 | g/m² | 225 | g/m² |
| cover ply | | | | | | | | |
| Material composition of textile | Cotton 93%, | | Cotton 93%, | | Cotton 91%, | | Cotton 91%, | |
| cover ply | Elastane 7% | | Elastane 7% | | Elastane 9% | | Elastane 9% | |
| Weight increase after immersion | — | | 6.5 | g/m² | — | | 8 | g/m² |
| in aqueous suspension comprising | | | | | | | | |
| 40 g/l of oxidized HDPE and | | | | | | | | |
| subsequent drying | | | | | | | | |
| Adhesive layer between textile | LDPE film, | | LDPE film, | | LDPE film, | | LDPE film, | |
| and substructure | 30 μm | | 30 μm | | 30 μm | | 30 μm | |
| CoF dry | 1.5 | | 1.5 | | 1.2 | | 1.2 | |
| CoF wet | 1.0 | | 1.0 | | 1.1 | | 1.1 | |
| Average running time in bending | 180 | h | 320 | h | 205 | h | 275 | h |
| fatigue life test at 130° C. | | | | | | | | |

| | | | | |
|---|---|---|---|---|
| Mass loss in wear test on a | 1.10% | 0.50% | 2.50% | 0.80% |
| diesel engine after idling for | | | | |
| 72 h | | | | |

Comparable friction results were obtained under wet and dry conditions (CoF) for belt variants A and B and also C and D. However, belts B and D, whose textile coating was provided with oxidized HDPE prior to vulcanization, showed markedly higher bending fatigue lives than the comparative belts A and C, whose textile coatings contained no oxidized HDPE.

Significantly lower mass losses were also registered in the wear test.

1.-15. (canceled)

16. An article comprising an elastic main body based on at least one thermoplastic elastomer or based on a vulcanizate having an article surface provided with a textile cover ply, wherein the textile cover ply is treated with partially oxidized polyethylene.

17. The article as claimed in claim 16, wherein the textile cover ply is selected from the group consisting of wovens, formed-loop knits, drawn-loop knits, nonwovens and combinations thereof.

18. The article as claimed in claim 16, wherein the textile cover ply comprises a material selected from the group consisting of cellulose, silk, cashmere, horsehair, aramid (AR), polyurethane (PU), polybenzimidazole (PBI), melamine (MEL), polybenzoxazole (PBO), carbon, polyamide (PA), polycarbonate (PC), polyethylene (PE), polypropylene (PP), polystyrene (PS), polyacrylic (PAN), acetate (CA), triacetate (CTA), polyvinyl alcohol (PVA), polyamideimide (PAI), polytrimethylene terephthalate (PTT), polyimide (PI), polybutylene terephthalate (PBT), polytetrafluoroethylene (PTFE), polyphenylene sulfide (PPS), polyetheretherketone (PEEK), polyester (PES) and combinations thereof.

19. The article as claimed in claim 18, wherein the textile cover ply comprises a material selected from cotton (CO), viscose (CV), PA6.6, PA6, PET, polyurethane or combinations thereof.

20. The article as claimed in claim 16, wherein the elastic main body is an elastic main body based on a thermoplastic polymer or a vulcanizate in the form of a vulcanized rubber mixture containing at least one rubber component and mixture ingredients, wherein the rubber component is selected from the group consisting of ethylene-propylene copolymer (EPM), ethylene-propylene-diene copolymer (EPDM), (partially) hydrogenated nitrile rubber (HNBR), chloroprene rubber (CR), fluororubber (FKM), natural rubber (NR), styrene-butadiene rubber (SBR), butadiene rubber (BR) and combinations thereof.

21. The article as claimed in claim 20, wherein the rubber component comprises ethylene-propylene copolymer (EPM), ethylene-propylene-diene copolymer (EPDM) or a blend of ethylene-propylene copolymer (EPM) and ethylene-propylene-diene copolymer (EPDM).

22. The article as claimed in claim 16, wherein the article is a band, strap, belt, hose, air spring bellows, expansion joint or a multilayer fabric web.

23. The article as claimed in claim 16, wherein the article is a drive belt, wherein the elastic main body comprises a top ply as the belt backing and a substructure having a force transmission zone, and wherein the top ply and/or the force transmission zone are provided with the textile cover ply.

24. The article as claimed in claim 23, wherein the drive belt is designed as a flat belt, V-belt, V-ribbed belt, toothed belt, clutch belt or elevator belt.

25. The article as claimed in claim 16, wherein the article is a V-ribbed belt, wherein the elastic main body is a vulcanizate based on ethylene-propylene copolymer (EPM), ethylene-propylene-diene copolymer (EPDM) or a blend of ethylene-propylene copolymer (EPM) and ethylene-propylene-diene copolymer (EPDM), and wherein the textile cover ply comprises a drawn-loop knit or formed-loop knit made of cotton.

26. The article as claimed in claim 25, wherein the textile cover ply further comprises an elastane yarn.

27. A process for producing an article comprising an elastic main body based on at least one thermoplastic elastomer or based on a vulcanizate, and having an article surface provided with a textile cover ply, wherein the process comprises:
(a) treating a sheetlike textile with partially oxidized polyethylene to provide the textile cover ply; and,
(b) applying the textile cover ply to the surface of the elastic main body based on the at least one thermoplastic elastomer or based on the vulcanizate.

28. The process as claimed in claim 27, wherein the treating of the sheetlike textile with partially oxidized polyethylene is carried out by immersing the sheetlike textile in a suspension containing the partially oxidized polyethylene in a concentration of from 20 to 60 g/l.

29. The process as claimed in claim 27, wherein the treating of the sheetlike textile with partially oxidized polyethylene is carried out by immersing the sheetlike textile in an emulsion containing the partially oxidized polyethylene in a concentration of from 20 to 60 g/l.

30. The process as claimed in claim 27, wherein the treating of the sheetlike textile with partially oxidized polyethylene is carried out by spraying the sheetlike textile with a suspension containing the partially oxidized polyethylene.

31. A process for producing an article comprising an elastic main body based on at least one thermoplastic elastomer or based on a vulcanizate, and having an article surface provided with a textile cover ply, wherein the process comprises:
(a) providing the article with the elastic main body based on at least one thermoplastic elastomer or based on a vulcanizate, and having a surface of the article provided with the textile cover ply, wherein the textile cover ply is untreated; and,
(b) treating the textile cover ply with partially oxidized polyethylene.

32. The process as claimed in claim 31, wherein the treating of the textile cover ply with partially oxidized polyethylene is carried out by immersing the textile cover ply in a suspension containing the partially oxidized polyethylene in a concentration of from 20 to 60 g/l.

33. The process as claimed in claim 31, wherein the treating of the textile cover ply with partially oxidized polyethylene is carried out by immersing the textile cover ply in an emulsion containing the partially oxidized polyethylene in a concentration of from 20 to 60 g/l.

34. The process as claimed in claim 31, wherein the treating of the textile cover ply with partially oxidized polyethylene is carried out by spraying the textile cover ply with a suspension containing the partially oxidized polyethylene.

35. The process as claimed in claim 31, wherein the treating of the textile cover ply with partially oxidized polyethylene is carried out by spraying the textile cover ply with an emulsion containing the partially oxidized polyethylene.
